(19) United States
(12) Patent Application Publication
(10) Pub. No.: US 2025/0347903 A1
(43) Pub. Date: Nov. 13, 2025

(54) OPTICAL OBSERVATION APPARATUS AND METHOD FOR PROVIDING AN OPTICAL OBSERVATION APPARATUS WITH A LASER PROTECTION FILTER

(71) Applicant: CARL ZEISS MEDITEC AG, Jena (DE)

(72) Inventors: Christian BEDER, Aalen (DE); Frank DEUBEL, Oberkochen (DE)

(21) Appl. No.: 19/199,362

(22) Filed: May 5, 2025

(30) Foreign Application Priority Data
May 7, 2024 (DE) 102024112777.5

(51) Int. Cl. G02B 21/00; G02B 21/04; G02B 21/22

(52) U.S. Cl. CPC G02B 21/0012; G02B 21/04; G02B 21/22

(57) ABSTRACT

An optical observation apparatus for use during a treatment of a treatment region by means of laser radiation is provided. The optical observation apparatus includes at least two partial beam paths and a number of optical elements, at least one of the optical elements having all the beam paths passing therethrough. At least one optical elements of the optical observation apparatus is provided with at least one coating which realizes a transmission characteristic suitable for blocking the laser radiation used during the treatment. The at least one optical element provided with the coating is one through which all the beam paths pass. In addition, a method for providing an optical observation apparatus with a laser protection filter is provided, wherein at least one optical element of the optical observation apparatus through which all the partial beam paths pass is provided with a coating which functions as a laser protection filter.

### CROSS-REFERENCE TO RELATED APPLICATIONS

The present application claims priority under 35 U.S.C. § 119 to German Patent Application No. 10 2024 112 777.5, filed May 7, 2024, the contents of which are incorporated by reference herein in their entirety.

The present invention relates to an optical observation apparatus for use during a treatment of a treatment region by means of laser radiation. In addition, the invention relates to a method for providing an optical observation apparatus with a laser protection filter.

Lasers have become an indispensable part of medical treatment. For example, in ophthalmosurgery, lasers are used during the treatment of both the anterior and posterior segments of the eye. For example, what is known as an after-cataract is treated during the treatment of the anterior segment of the eye. An after-cataract is post-operative clouding that follows the insertion of an intraocular lens. Laser treatment can be used to remove this clouding. In the context of treatment of the posterior segment, laser radiation is for example used to re-secure detached regions of the retina to the tissue located behind the retina. To protect the eyes of the physician and, where applicable, of their assistant, use is made of what are known as physician protection filters which for example may be introduced into the beam path of a surgical microscope. For example, such a physician protection filter is described in DE 44 09 506 A1. This radiation protection filter is pivoted-in between a beam splitter that deflects the laser radiation in the direction of the object to be treated and the two main objectives of a surgical microscope. However, such filters require an additional pivoting mechanism below the main objective, rendering the surgical microscope more complex and requiring installation space for the pivoting mechanism.

Moreover, U.S. Pat. No. 5,528,426 A has disclosed a surgical microscope having a beam splitter for output coupling beam paths from the stereoscopic partial beam paths of a stereoscopic main observer beam path. A respective laser protection filter is present at the distal end of the beam splitter for each stereoscopic partial beam path of the main observer beam path.

Vis-à-vis this prior art, a first problem addressed by the present invention is that of providing an optical observation apparatus for use during a treatment of a treatment region by means of laser radiation, which optical observation apparatus includes a laser protection filter which does not require any additional pivoting mechanism and needs as few elements as possible. In addition, a second problem addressed by the present invention is that of providing a method by which an optical observation apparatus for use during a treatment of a treatment region by means of laser radiation can be provided with a laser protection filter without requiring an additional pivoting mechanism, the laser protection filter needing as few elements as possible.

DE 197 34 655 A1 discloses a surgical microscope with an optical element that can be used to couple sighting and therapeutic radiation into the beam path in the direction of a patient's eye. This optical element has areas that are impervious to therapeutic radiation, thereby protecting the eyes of the person performing the treatment.

U.S. Pat. No. 5,438,456 A describes a stereo surgical microscope with an inverter for swapping the left and right observation beam paths. This inverter is equipped with a laser safety filter to protect the eyes of a treating person.

The first problem is solved according to claim 1 by an optical observation apparatus for use during a treatment of a treatment region by means of laser radiation, and the second problem is solved according to claim 5 by a method for providing an optical observation apparatus with a laser protection filter. The dependent claims contain advantageous configurations of the invention.

According to a first aspect of the invention, an optical observation apparatus for use during a treatment of a treatment region by means of laser radiation is provided. The optical observation apparatus comprises at least two beam paths and a number of optical elements, at least one of the optical elements having all the beam paths passing therethrough. At least one optical element of the optical observation apparatus is provided with at least one coating which realizes a transmission characteristic suitable for blocking the laser radiation used during the treatment. According to the invention, the at least one optical element provided with the coating is one through which all the beam paths pass. In this case, the beam paths can comprise e.g. stereoscopic partial beam paths. Additionally or alternatively, they can also comprise main and co-observer beam paths, documentation beam paths, etc., and these in turn can comprise stereoscopic partial beam paths. The optical observation apparatus has a main objective comprising the optical element with the at least one coating.

An optical observation apparatus should be understood to mean an apparatus for observing a tissue region, for example a surgical microscope, a slit lamp, etc., the beam paths of which lead to at least one eyepiece and/or to at least one camera.

For example, a transmission characteristic can be represented by a transmission curve, i.e. a curve that represents the transmission as a function of wavelength. In this context, the transmission characteristic of the at least one coating can be realized by a single colored coating, which forms a color filter, or in the form of an interference layer system, which forms an interference filter. The filter effect in a color filter is based on the absorption of the spectral range to be removed, whereas in an interference filter said filter effect is based on the spectral range to be removed being selectively reflected by means of interference. Particularly narrow passbands can be realized with interference filters in particular.

Within the meaning of the invention, laser radiation should be considered blocked if it is attenuated to such an extent that it cannot cause injury to the eye of a user who is observing the treatment region with the optical observation apparatus and/or that it does not lead to the overexposure of an image sensor.

Within the meaning of the invention, an optical element is an element that acts on a beam for the purpose of modifying said beam. The action that modifies the beam may be a focusing of the beam, a scattering of the beam, a deflection of the beam, an alteration of the cross-sectional shape of the beam, a change in the optical path length of rays passing therethrough, etc. The action that modifies the beam may be implemented refractively, reflectively or diffractively.

As a result of the laser protection filter being formed by at least one coating with which at least one optical element of the optical observation apparatus is provided, it is not necessary to pivot an additional laser protection filter, i.e. an additional element with a transmission characteristic suitable for blocking the laser radiation, into the beam paths. In this way, an additional pivoting mechanism can be avoided in comparison with the prior art mentioned in the introduction. Moreover, an additional optical element for filtering out the laser radiation does not need to be integrated into the optical observation apparatus.

As a result of all the beam paths passing through the at least one optical element provided with the coating in the optical observation system of the present invention, moreover, a dedicated optical element functioning as a laser protection filter does not need to be present for each beam path, which is advantageous particularly in the case of optical observation apparatuses having a large number of beam paths.

Since the laser radiation generally has a very narrow bandwidth, the coating may have a transmission characteristic that blocks a very narrow spectral range. Typically, it is possible to use a transmission characteristic with a stop band that has a width of only 20 nm, in particular 10 nm, and that is centered about the centroid wavelength of the laser radiation, which may be at 532 nm, for example. Since the wavelength range removed from the spectrum, being 20 nm, in particular 10 nm, is very narrow, blocking the laser radiation has only a very small influence on the color representation attained by the optical observation apparatus. As a result, color distortions are so small that the coating that forms the laser protection filter does not adversely affect the rest of the use of the optical observation apparatus.

The transmission characteristic may be attained by a single coating that blocks only a narrow transmission range. However, it is alternatively also possible to realize the transmission characteristic by way of two coatings, which each have an edge in the transmission. If one of the two coatings has a high transmission in a wavelength range below a first cut-off wavelength and a low transmission above the first cut-off wavelength, the other of the two coatings has a low transmission in a wavelength range below a second cut-off wavelength and a high transmission above the second cut-off wavelength, and the first cut-off wavelength is below the second cut-off wavelength, a narrowband transmission range can be obtained using the two coatings.

If the at least two beam paths comprise at least one main observer beam path and one co-observer beam path, it is advantageous if the optical element with the at least one coating is situated in a region of the optical observation apparatus in which both the main observer beam path and the at least one co-observer beam path pass through it. In this way, in order to realize the laser protection filter, just a single optical element needs to be provided with at least one coating having a transmission characteristic suitable for blocking the laser radiation.

That the main objective embodied as the optical element with the at least one coating is particularly advantageous. Firstly, the main objective can be exchanged by the user relatively easily themself, and so existing optical observation apparatuses can be retrofitted very easily, and, secondly, the main objective constitutes that optical element through which generally all the beam paths, in particular also both the main observer beam path and possible co-observer beam paths, always pass.

Since a main objective usually comprises a plurality of optically effective surfaces, in particular at least two optically effective surfaces, it is advantageous if the at least one coating is applied to that optical surface on which incident light rays of the beam paths have the smallest angle of incidence on average. Especially if the at least one coating is embodied an interference layer system, the effect of the laser protection filter deteriorates as the angle of incidence increases. In this case, the average may for example be the arithmetic mean of the angles between the light rays of the beam paths incident on the optical surface and the surface normal at the respective point of incidence. However, a weighted mean or a root mean square is also conceivable, in principle.

Main objectives are typically embodied as achromatic or apochromatic objectives in order to minimize chromatic aberrations. Achromatic or apochromatic objectives are composed of two or three lenses, at least two lenses of which form a so-called cemented member.

In this case, the cemented surface, i.e. the surface at which the two lenses are cemented together, is that surface on which the incident light rays of the beam paths have the smallest angle of incidence on average. If at least one of the optically effective surfaces of the main objective is a cemented surface, it is therefore advantageous if the at least one coating is present on the cemented surface.

According to a second aspect of the present invention, a method is provided by which an optical observation apparatus is provided with a laser protection filter having a transmission characteristic suitable, during a treatment of a treatment region by means of laser radiation, for blocking the laser radiation used during the treatment. In this case, the optical observation apparatus comprises at least two partial beam paths and a number of optical elements. In the method, at least one optical element through which all the beam paths pass is provided with a coating which realizes the transmission characteristic, such that the optical element with the at least one coating functions as a laser protection filter. For that matter, an optical element of the main objective is provided with the at least one coating. In this case, the beam paths can comprise e.g. stereoscopic partial beam paths. Additionally or alternatively, they can also comprise main and co-observer beam paths, documentation beam paths, etc., and these in turn can comprise stereoscopic partial beam paths.

Forming the laser protection filter by coating at least one optical element of the optical observation apparatus makes it possible to realize the laser protection filter without the need to provide the optical observation apparatus with an additional element. As a result of the coating in the context of the present invention being applied to an optical element through which all the beam paths of the optical observation apparatus pass, moreover, a dedicated optical element does not need to be coated for each beam path, which is advantageous particularly in the case of optical observation apparatuses having a large number of beam paths. Moreover, an additional pivoting mechanism can also be avoided in comparison with the prior art mentioned in the introduction.

If the at least two partial beam paths comprise at least one main observer beam path and one co-observer beam path, it is advantageous if the at least one coating is provided for an optical element of the optical observation apparatus which is situated in a region of the optical observation apparatus in which both the main observer beam path and the at least one co-observer beam path pass through it. In order to provide the optical observation apparatus with the laser protection filter, just a single optical element then needs to be provided with at least one coating having a transmission characteristic suitable for blocking the laser radiation.

That an optical element of the main objective of the optical observation apparatus is provided with the at least one coating is advantageous since, firstly, the main objective can be exchanged by the user relatively easily themself, and so existing optical observation apparatuses can be retrofitted very easily, and, secondly, the main objective often constitutes that optical element through which all the partial beam paths and, in the case of co-observer beam paths, generally also the co-observer beam paths always pass.

A main objective typically comprises a plurality of optically effective surfaces. In the context of the invention, it is advantageous to provide the at least one coating for that optical surface of the main objective on which incident light rays of the beam paths have the smallest angle of incidence an average since, particularly when an interference layer system is applied, the effect of the laser protection filter deteriorates as the angle of incidence increases.

The optically effective surfaces of the main objective can also comprise a cemented surface, as is the case e.g. for achromatic or apochromatic main objectives. The cemented surface, in particular, can be provided with the at least one coating in this case. The cemented surface in this case is generally that surface on which the incident light rays of the beam paths have the smallest angle of incidence on average, and is thus particularly suitable for applying the at least one coating.

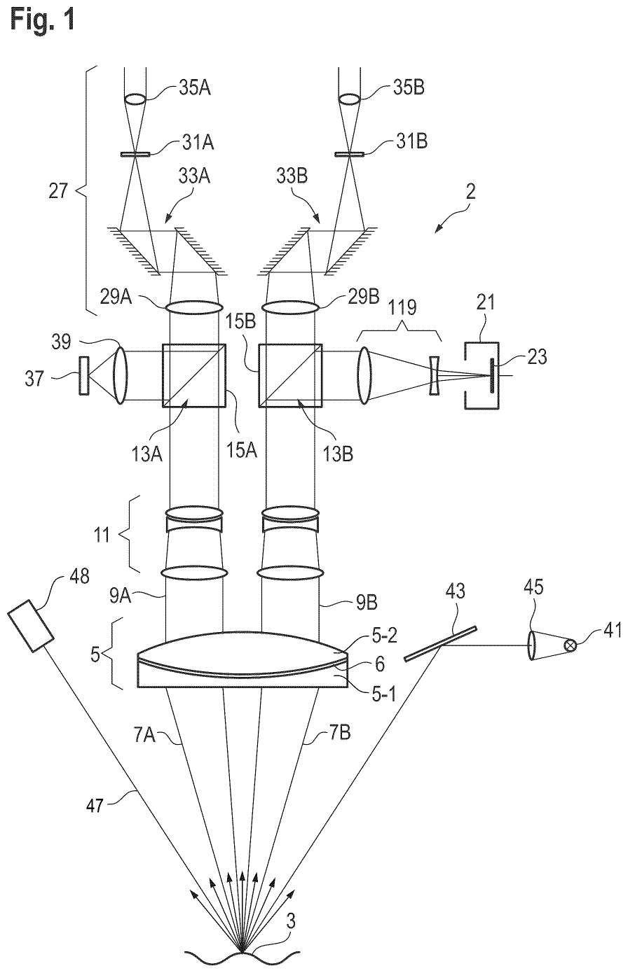

FIG. 1 shows a surgical microscope as a first example of an optical observation apparatus for use during a treatment of a treatment region by means of laser radiation.

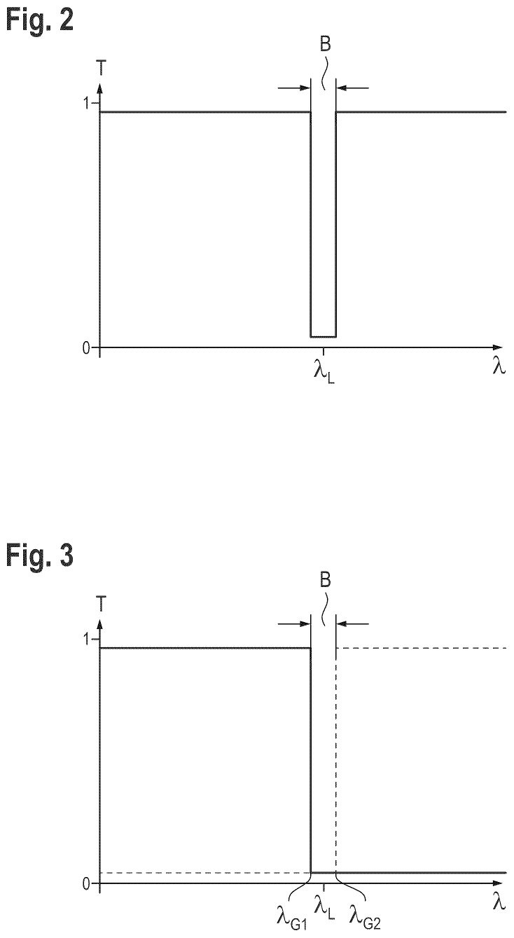

FIG. 2 shows a first example of a transmission characteristic of one coating.

FIG. 3 shows a second example of a transmission characteristic of a coating system consisting of at least two coatings.

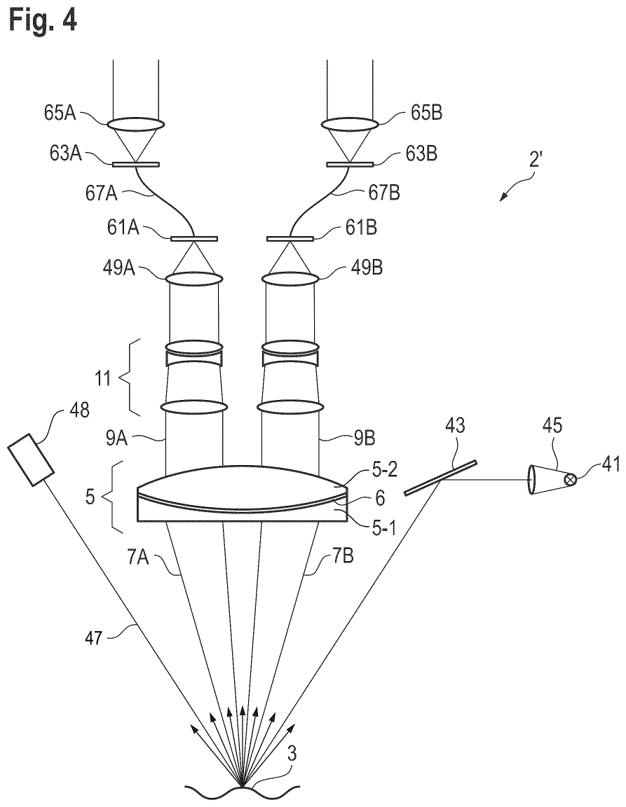

FIG. 4 shows an alternative surgical microscope as a second example of an optical observation apparatus for use during a treatment of a treatment region by means of laser radiation.

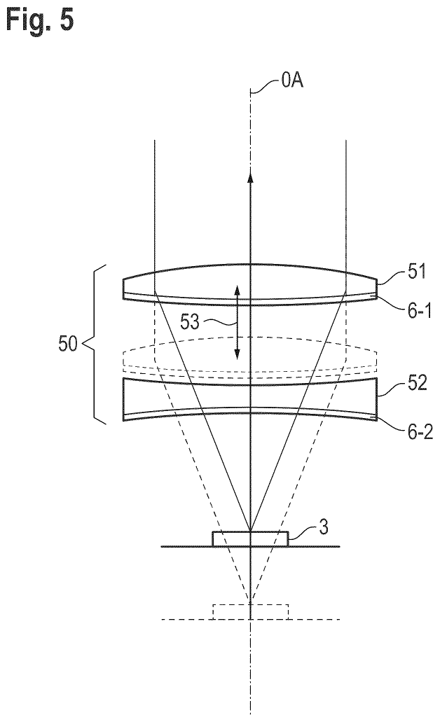

FIG. 5 shows an alternative main objective of a surgical microscope.

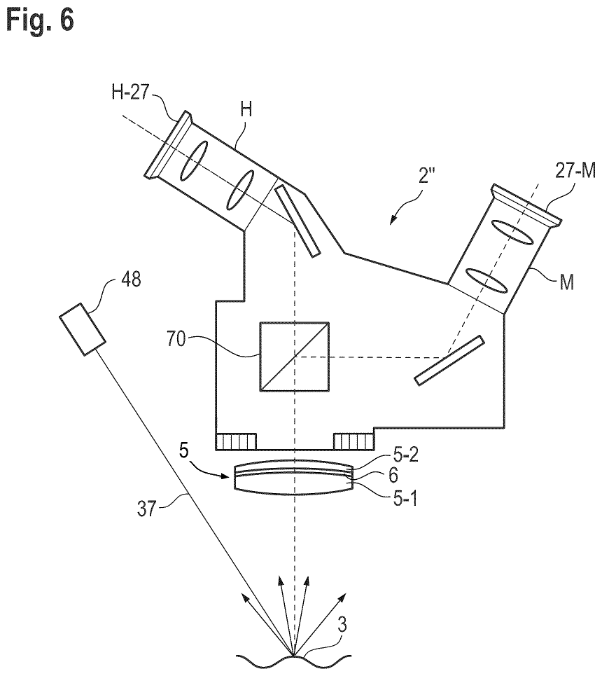

FIG. 6 shows a further alternative surgical microscope as a third example of an optical observation apparatus for use during a treatment of a treatment region by means of laser radiation.

A surgical microscope 2 as an exemplary embodiment of an optical observation apparatus according to the invention is described below with reference to FIG. 1. As essential component parts, the surgical microscope 2 shown in FIG. 1 comprises an objective 5 that faces an object field 3 and may be embodied as an achromatic or apochromatic objective in particular. In the present exemplary embodiment, the objective 5 consists of two partial lenses 5-1 and 5-2 cemented together, which jointly form an achromatic objective 5 and have three optically effective surfaces, namely the entrance surface facing the object plane 3, the exit surface facing away from the object plane 3, and the cemented surface, i.e. the surface at which the lens 5-1 makes contact with the lens 5-2. In the present exemplary embodiment, a coating 6 is present on the cemented surface, and has the effect that the main objective 5 simultaneously functions as a laser protection filter, as will also be explained later.

The object field 3 is arranged in the focal plane of the objective 5 such that it is imaged at infinity by the objective 5. Expressed differently, a divergent beam 7A, 7B emanating from the object field 3 is converted into a parallel beam 9A, 9B during its passage through the objective 5. The beams 7A, 7b and 9A, 9B define beam paths of the surgical microscope, specifically stereoscopic partial beam paths.

A magnification changer 11 is arranged on the observer side of the objective 5 and may be embodied either as a zoom system for changing the magnification factor in a continuously variable manner or as what is known as a Galilean changer for changing the magnification factor in a stepwise manner. In a zoom system, constructed by way of example from a lens combination having three lenses, the two object-side lenses may be displaced in order to vary the magnification factor. In actual fact, however, the zoom system may also have more than three lenses, for example four or more lenses, in which case the outer lenses then may also be arranged in a fixed manner. In a Galilean changer, by contrast, there are a plurality of fixed lens combinations which represent different magnification factors and which can be introduced into the stereoscopic partial beam paths defined by the partial beams 9A, 9B in alternation. Both a zoom system and a Galilean changer convert an object-side parallel beam into an observer-side parallel beam with a different beam diameter. In the present exemplary embodiment, the magnification changer 11 is already part of the binocular beam path of the surgical microscope 1, i.e. it has a dedicated lens combination for each stereoscopic partial beam path 9A, 9B of the surgical microscope 1. In the present exemplary embodiment, a magnification factor is set by means of the magnification changer 11 by way of a motor-driven actuator which, together with the magnification changer 11, is part of a magnification changing unit for setting the magnification factor.

The magnification changer 11 is followed on the observer side by an interface arrangement 13A, 13B, by means of which external apparatuses can be connected to the surgical microscope 2 and which comprises beam splitter prisms 15A, 15B in the present exemplary embodiment. However, in principle, use can also be made of other types of beam splitters, for example partly transmissive mirrors. In the present exemplary embodiment, the interfaces 13A, 13B serve to output couple a beam from the stereoscopic partial beam path 9B of the surgical microscope 2 (beam splitter prism 15B) and to input couple a beam into the stereoscopic partial beam path 9A of the surgical microscope 2 (beam splitter prism 15A).

In the present exemplary embodiment, the beam splitter prism 15A in the stereoscopic partial beam path 9A serves to reflect information or data for a viewer via the beam splitter prism 15A into the stereoscopic partial beam path 9A of the surgical microscope 2 with the aid of a display 37, for example a digital mirror device (DMD) or an LCD display, and an associated optical unit 39. A camera adapter 19 with a camera 21 fastened thereto, said camera being equipped with an electronic image sensor 23, for example with a CCD sensor or a CMOS sensor, is arranged at the interface 13B in the other stereoscopic partial beam path 9B. By means of the camera 21, it is possible to record an electronic image, and in particular a digital image, of the tissue region 3, for instance for documentation purposes or for displaying an image of the object field 3 on a monitor.

A binocular tube 27 follows the interface 13 on the observer side. It has two tube objectives 29A, 29B, which focus the respective parallel beam 9A, 9B onto an intermediate image plane 31, i.e. image the observation object 3 onto the respective intermediate image plane 31A, 31B. Finally, the intermediate images situated in the intermediate image planes 31A, 31B are imaged in turn at infinity by eyepiece lenses 35A, 35B, with the result that a viewer can view the intermediate image with a relaxed eye. Moreover, an increase in the distance between the two partial beams 9A, 9B is implemented in the binocular tube by means of a mirror system or by means of prisms 33A, 33B in order to adapt said distance to the interocular distance of the viewer. In addition, image erection is carried out by the mirror system or the prisms 33A, 33B.

The surgical microscope 2 is additionally equipped with an illumination device, by means of which the object field 3 can be illuminated with broadband illumination light. For this purpose, the illumination device in the present exemplary embodiment has a white-light source 41, for instance a halogen lamp or a gas discharge lamp. The light emanating from the white-light source 41 is directed via a deflection mirror 43 or a deflection prism in the direction of the object field 3 in order to illuminate the latter. Furthermore, an illumination optical unit 45 is present in the illumination device, said illumination optical unit ensuring uniform illumination of the entire observed object field 3.

Reference is made to the fact that the illumination beam path illustrated in FIG. 1 is highly schematic and does not necessarily reproduce the actual course of the illumination beam path. In principle, the illumination beam path can be embodied as so-called oblique illumination, which comes closest to the schematic illustration in FIG. 1. In such oblique illumination, the beam path extends at a relatively large angle (6° or more) with respect to the optical axis of the objective 5 and, as illustrated in FIG. 1, may extend completely outside the objective. Alternatively, however, there is also the possibility of allowing the illumination beam path of the oblique illumination to extend through a marginal region of the objective 5. A further possibility for the arrangement of the illumination beam path is so-called 0° illumination, in which the illumination beam path extends through the objective 5 and is input coupled into the objective between the two partial beam paths 9A, 9B, along the optical axis of the objective 5 in the direction of the object field 3. Finally, there is also the possibility of embodying the illumination beam path as so-called coaxial illumination, in which a first illumination partial beam path and a second illumination partial beam path are present. The partial beam paths are input coupled into the surgical microscope in a manner parallel to the optical axes of the observation partial beam paths 9A, 9B by way of one or more beam splitters such that the illumination extends coaxially in relation to the two observation partial beam paths.

The surgical microscope 2 illustrated in FIG. 1 as one exemplary embodiment of an optical observation apparatus is adapted to the use during a treatment of a treatment region by means of laser radiation 247 of a laser 48. In this case, the treatment region is represented by the object field 3 in FIG. 1. As is indicated by the arrows in FIG. 1, laser radiation is reflected and scattered by the object field 3 and can thus pass into the stereoscopic partial beam paths 9A, 9B of the surgical microscope 2. This poses a hazard for the eyes of the treating physician looking through the surgical microscope 2. The surgical microscope 2 is therefore equipped with a laser protection filter.

In the exemplary embodiment illustrated in FIG. 1, the laser protection filter is realized as coating 6 in the region of the cemented surface between the first lens 5-1 and the second lens 5-2 of the main objective 5. The coating provides a transmission characteristic which has a very low transmission T close to 0 in a narrow spectral range around the centroid wavelength λ_{L} of the laser radiation 47, whereas it has a high transmission T close to 1 in all remaining spectral ranges, as is illustrated schematically in FIG. 2. Hence the coating acts as a band-stop filter which blocks the narrow spectral range around the centroid wavelength λ_{L} of the laser radiation 47. In this context, the width of the stop band B of the coating 6 is typically a few nanometers, for example no more than 20 nm, preferably no more than 10 nm, with the centroid wavelength AL of the laser radiation forming the center of the stop band B. In the present exemplary embodiment, the centroid wavelength λ_{L} of the laser radiation is 532 nm. A transmission characteristic as illustrated in FIG. 2 may be realized using a spectral filter that absorbs or reflects the narrow spectral range around the centroid wavelength λ_{L} of the laser radiation. However, the transmission characteristic can be realized particularly advantageously with the aid of an interference layer system. In such an interference layer system, filtering is not based on absorption or scattering but on reflection, created by interference, in the narrow spectral range around the centroid wavelength λ_{L} of the laser radiation 47.

A transmission characteristic as shown schematically in FIG. 2 can also be realized by the interplay of two coatings. This variant is shown schematically in FIG. 3. In the interplay of the two coatings, a first coating has a high transmission close to 1 at wavelengths below a first cut-off wavelength λ_{G1} and a very low transmission close to 0 above this first cut-off wavelength λ_{G1}. A second coating has a very low transmission close to 0 for wavelengths below a second cut-off wavelength λ_{G2} and a very high transmission close to 1 for wavelengths above the second cut-off wavelength λ_{G2}. Both coatings thus act as edge filters. If the first cut-off wavelength λ_{G1} is then shorter than the second cut-off wavelength λ_{G2}, this gives rise to a stop band B between the first cut-off wavelength λ_{G1} and the second cut-off wavelength λ_{G2} which has a width corresponding to the absolute value of the difference between the cut-off wavelengths λ_{G2} and λ_{G1}. In this way, The two coatings jointly result in a transmission characteristic with a narrow stop band B.

With the aid of the coating 6 described, the eyes of the treating physician can be protected against injury resulting from reflected or scattered laser radiation. In addition, the coating 6 can also prevent the image recorded by the camera 21 from being overexposed by reflected or scattered laser radiation.

A digital surgical microscope 2′ as a further exemplary embodiment of an optical observation apparatus according to the invention is described below with reference to FIG. 4. In the digital surgical microscope 2′, the main objective 5 with the coating 6 for filtering out the laser radiation 47, the magnification changer 11, which merely represents an option in the digital surgical microscope 2′ and hence need not necessarily be present, and the illumination system 41, 43, 45 do not differ from the surgical microscope 2 with an optical viewing unit, depicted in FIG. 1. The difference lies in the fact that the surgical microscope 2′ shown in FIG. 4 does not comprise an optical binocular tube. Instead of the tube objectives 29A, 29B from FIG. 1, the surgical microscope 2′ from FIG. 4 comprises focusing lenses 49A, 49B, with which the binocular observation beam paths 9A, 9B are imaged onto digital image sensors 61A, 61B. In this case, the digital image sensors 61A, 61B can be CCD sensors or CMOS sensors, for example. The images recorded by the image sensors 61A, 61B are transmitted to digital displays 63A, 63B, which may be embodied as LED displays, as LCD displays, or as displays based on organic light-emitting diodes (OLEDs). As in the present example, eyepiece lenses 65A, 65B can be assigned to the displays 63A, 63B, by means of which lenses the images presented on the displays 63A, 63B are imaged at infinity such that a viewer can view said images with relaxed eyes. The displays 63A, 63B and the eyepiece lenses 65A, 65B may be part of a digital binocular tube; however, they may also be part of a head-mounted display (HMD) such as for instance a pair of smartglasses. Even though FIG. 4 shows a transmission of the images recorded by the image sensors 61A, 61B to the displays 63A, 63B of a digital binocular tube by means of cables 67A, 67B, the images may also be transmitted wirelessly to the displays 63A, 63B, especially when the displays 63A, 63B are part of a head-mounted display. Moreover, there is the option of representing the recorded images as stereoscopic images on a large monitor that is viewed by staff in the operating theater using suitable 3D glasses. For the purpose of differentiating the stereoscopic partial images, the latter during the representation of the stereoscopic images on the monitor can be represented e.g. with different polarizations of the light emitted by the monitor. The 3D glasses then contain switchable polarizers that are switched synchronously with the representation of the partial images on the monitor.

In the digital surgical microscope shown in FIG. 4, the coating 6 serves to prevent the image recorded by the camera 21 from being overexposed by reflected or scattered laser radiation.

In the case of the surgical microscopes 2, 2′ shown in FIGS. 1 and 4, the objective 5 consists of just one achromatic lens or one apochromatic lens. However, it is also possible to use an objective lens system made of a plurality of lenses, in particular what is known as a zoom lens, by means of which it is possible to vary the working distance of the surgical microscope 2, 2′, i.e., the distance between the object-side focal plane, in which the object field 3 is situated, and the vertex of the first object-side lens surface of the objective, which is also referred to as front focal distance. The object field 3 arranged in the focal plane is imaged at infinity by a zoom lens, too, and so a parallel beam is present on the observer side.

One example of a zoom lens is depicted schematically in FIG. 5. The zoom lens 50 comprises a positive member 51, i.e. an optical element with positive refractive power, depicted schematically as a convex lens in FIG. 5. Moreover, the zoom lens 50 comprises a negative member 52, i.e. an optical element with negative refractive power, depicted schematically as a concave lens in FIG. 5. The negative member 52 is situated between the positive member 51 and the object field 3, 3′. In the depicted zoom lens 50, the negative member 52 has a fixed arrangement, whereas, as indicated by the double- headed arrow 53, the positive member 51 is arranged to be displaceable along the optical axis OA. When the positive member 51 is displaced into the position illustrated by dashed lines in FIG. 5, the back focal length increases, and so there is an increase in the working distance between the surgical microscope 2 and the object field 3.

Even though the positive member 51 has a displaceable configuration in FIG. 5, it is also possible, in principle, to arrange the negative member 52 to be movable along the optical axis OA instead of the positive member 51. However, the negative member 52 often forms the last lens element of the zoom lens 50. A stationary negative member 52 therefore offers the advantage of making it easier to seal the interior of the surgical microscope 2 from external influences. Furthermore, it is noted that, even though the positive member 51 and the negative member 52 in FIG. 5 are only illustrated as individual lens elements, each of these members may also be realized in the form of a lens group or a cemented element instead of in the form of an individual lens element, for example in order to design the zoom lens to be achromatic or apochromatic.

In the present exemplary embodiment, the zoom lens 50 has four optically effective surfaces, specifically the surfaces of the positive member 51 and negative member 53 facing the object field 3 and the surfaces of the positive member 51 and negative member 52 facing away from the object field 3. In the present exemplary embodiment, the surfaces of the lenses 51 and 52 facing the object field 3 have respectively a coating 6-1, 6-2. These coatings 6-1, 6-2 each act as an edge filter, the first coating 6-1 having a first cut-off wavelength λ_{G1} and the second coating 6-2 having a second cut-off wavelength λ_{G2}, and the cut-off wavelength λ_{G1} being shorter than the second cut-off wavelength λ_{G2}, as shown in FIG. 3. Hence, the coatings 6-1, 6-2 jointly result in a transmission characteristic with a narrow stop band B centered around the centroid wavelength λ_{L} of the laser radiation 47. In this case, it is irrelevant which of the two coatings 6-1, 6-2 is the coating with the first cut-off wavelength λ_{G1} and which is the coating with the second cut- off wavelength λ_{G2}.

FIG. 6 shows, as a further exemplary embodiment of an optical observation apparatus according to the invention, a surgical microscope 2″ having a main observer beam path H and a co-observer beam path M as beam paths. In the present exemplary embodiment, both the main observer beam path H and the co-observer beam path M in turn each have stereoscopic partial beam paths, although they are not discernible in detail in FIG. 6 owing to the view chosen. The surgical microscope 2″ shown in FIG. 6 therefore comprises a total of at least four beam paths. If it additionally comprises a monoscopic or stereoscopic documentation beam path (not illustrated), the surgical microscope of the present exemplary embodiment can also have more than four beam paths. Both the main observer beam path H and the co-observer beam path M have a respective binocular tube 27-H, 27-M.

The output coupling of the co-observer beam path M is effected by means of a beam splitter 70 disposed downstream of the main objective 5 in the beam path. In the present exemplary embodiment, this beam splitter 70 is a large beam splitter, i.e. a beam splitter which extends over both stereoscopic partial beams of the main observer beam path H and couples the two stereoscopic partial beams of the co-observer beam path M out from the stereoscopic partial beams of the main observer beam path H. Alternatively, there is the possibility of arranging the observation pupils of the stereoscopic partial beam paths of the co-observer beam path M in a manner rotated by 90° relative to the observation pupils of the stereoscopic partial beam paths of the main observer beam path H. In this case, small beam splitters can be used, which can be arranged outside the stereoscopic partial beam paths of the main observer beam path H. This makes it possible to avoid a loss of light in the main observer beam path H as a result of the co-observer beam path M being coupled out. If a monoscopic documentation beam path is intended to be coupled out, this can be coupled out from one of the stereoscopic partial beam paths of either the main observer beam path H or the co-observer beam path M. However, there is also the possibility of coupling it out between the stereoscopic partial beam paths. If a stereoscopic documentation is intended to be effected, corresponding stereoscopic partial beam paths are coupled out from the stereoscopic partial beam paths of either the main observer beam path H or the co-observer beam path M.

The main objective 5 of the surgical microscope shown in FIG. 6 is embodied in a manner such as has been described with reference to FIG. 1. As a result of the coating 6 being applied to an optically effective surface of the main objective 5, the coating acts as a laser protection filter both for the main observer beam path H and for the co-observer beam path M. Instead of the objective 5 shown in FIG. 6, however, a zoom lens such as has been explained on the basis of the example in FIG. 5 can also be used in the surgical microscope. Since the coating 6 is arranged on the main objective in this case, too, this coating likewise acts as a laser protection filter both for the main observer beam path H and for the co-observer beam path M.

The binocular tubes 27-H, 27-M shown in FIG. 6 may be either purely optical binocular tubes such as have been described with reference to FIG. 1, or digital binocular tubes such as have been described with reference to FIG. 4. Moreover, it is also possible for one of the binocular tubes 27-H, 27-M to be configured in purely optical fashion, and the other in digital fashion. Particularly in the case of a purely optical binocular tube 27-H, 27-M, in the beam path leading to this binocular tube 27-H, 27-M an interface for output coupling part of the beam path in the direction of one or more image sensors can also be present. There is likewise the possibility of at least one further beam path, for instance a documentation beam path or a further co-observer beam path, also being present besides the main observer beam path H and the co-observer beam path M. Especially the documentation beam path can also be embodied here as a monoscopic beam path.

The present invention has been described in detail on the basis of exemplary embodiments for explanatory purposes. However, a person skilled in the art recognizes that there can be departures from the exemplary embodiments within the scope of the present invention, as claimed in the appended claims. In this regard, for example, the coating of the zoom lens can be embodied as a single coating, as has been described with reference to FIG. 2. Moreover, there is the possibility of arranging the coating in the region of a cemented surface if the zoom lens has at least one cemented member. Likewise, the objective of the surgical microscopes 2, 2′ illustrated in FIGS. 1 and 4, instead of featuring in each case the single coating, can also feature in each case two coatings and only upon the interaction thereof is the stop band B formed thereby, as has been described with reference to FIG. 3. Therefore, the present invention is not intended to be limited by the exemplary embodiments but rather only by the appended claims.

### LIST OF REFERENCE SIGNS

2,2′, 2″ Surgical microscope
3 Operating field
5 Objective
5-1 Lens
5-2 Lens
6 Coating
6-1 Coating
6-2 Coating
7A,B Divergent beams
9 Beam
9A,B Stereoscopic partial beam path
11 Magnification changer
13A,B Interface arrangement
15A,B Beam splitter prism
19 Camera adapter
21 Camera
23 Image sensor
27-H Binocular tube
27-M Binocular tube
29A,B Tube objective
31A,B Intermediate image plane
33A,B Prism
35A,B Eyepiece lens
37 Display
39 Optical unit
41 White-light source
43 Deflection mirror
45 Illumination optical unit
47 Laser radiation
48 Laser
49A,B Focusing lens
50 Zoom lens
51 Positive member
52 Negative member
53 Displacement path
61A,B Image sensor
63A,B Display
65A,B Eyepiece lens
67A,B Cable
70 Beam splitter
B Stop band
H Main observer beam path
M Co-observer beam path
OA Optical axis
T Transmission

1. An optical observation apparatus for use during a treatment of a treatment region by means of laser radiation, comprising:
at least two beam paths and a number of optical elements, at least one of the optical elements having all the beam paths passing therethrough, and
at least one optical element of the optical observation apparatus is provided with at least one coating which realizes a transmission characteristic suitable for blocking the laser radiation used during the treatment,
wherein the at least one optical element provided with the coating is one through which all the beam paths pass, and
the optical observation apparatus has a main objective comprising the optical element with the at least one coating.

2. The optical observation apparatus as claimed in claim 1, wherein the at least two beam paths comprise at least one main observer beam path and one co-observer beam path and the optical element with the at least one coating is situated in a region of the optical observation apparatus in which both the main observer beam path and the at least one co-observer beam path pass through it.

3. (canceled)

4. The optical observation apparatus as claimed in claim 1, wherein the main objective comprises a plurality of optically effective surfaces, and the at least one coating is present on that optical surface on which incident light rays have the smallest angle of incidence on average.

5. The optical observation apparatus as claimed in claim 4, wherein at least one of the optically effective surfaces of the main objective is a cemented surface, and the at least one coating is present on the cemented surface.

6. A method for providing an optical observation apparatus with a laser protection filter with a transmission characteristic suitable, during a treatment of a treatment region by means of laser radiation, for blocking the laser radiation used during the treatment, the optical observation apparatus comprising at least two beam paths and a number of optical elements,
wherein at least one optical element through which all the beam paths pass is provided with a coating which realizes the transmission characteristic, such that the optical element with the at least one coating functions as a laser protection filter, and
the optical observation apparatus has a main objective, and an optical element of the main objective is provided with the at least one coating.

7. The method as claimed in claim 6, wherein the at least two beam paths comprise at least one main observer beam path and one co-observer beam path and the optical element provided with the at least one coating is situated in a region of the optical observation apparatus in which both the main observer beam path and the at least one co-observer beam path pass through it.

8. (canceled)

9. The method as claimed in claim 6, wherein the main objective comprises a plurality of optically effective surfaces, and that optical surface on which incident light rays of the observation beam path have the smallest angle of incidence on average is provided with the at least one coating.

10. The method as claimed in claim 9, wherein at least one of the optically effective surfaces of the main objective is a cemented surface, and the cemented surface is provided with the at least one coating.
